(19) United States
(12) Patent Application Publication
(10) Pub. No.: US 2010/0246337 A1
(43) Pub. Date: Sep. 30, 2010

(54) ATTRACTOR TIMEPIECE APPARATUS AND METHOD FOR SELF IMPROVEMENT

(76) Inventor: JOHN COWGILL, Neotsu, OR (US)

Correspondence Address: MARGER JOHNSON & MCCOLLOM, P.C., 210 SW MORRISON STREET, SUITE 400, PORTLAND, OR, 97204, US

(21) Appl. No.: 12/411,316

(22) Filed: Mar. 25, 2009

(51) Int. Cl. G04F 8/00

(52) U.S. Cl. 368/109; 368/107

(57) ABSTRACT

An attractor timepiece apparatus. The apparatus may comprise a housing, a surface coupled to the housing, a plurality of numerals on the surface spanning more than 60 seconds, at least one actuator, and a rotatable arm structured to begin rotating from a starting position responsive to the actuator. The rotatable arm may be structured to automatically stop rotating at the starting position. Also disclosed is a method for self improvement using an attractor timepiece apparatus. The timepiece apparatus may begin counting from a starting position responsive to a first input from a user. The timepiece apparatus may notify the user to start meditating using a first sensory effect. Thereafter, a plurality of seconds may be traversed to an ending position more than 60 seconds from the starting position, and the timepiece apparatus may automatically stop counting at the ending position. The timepiece apparatus may notify the user to stop meditating using a second sensory effect.

### FIELD OF THE INVENTION

This application pertains to a timepiece, and more particularly, to an attractor timepiece apparatus and method for self improvement.

### BACKGROUND

Meditation is a widespread practice. Many believe that meditating can bring about positive improvements in one's life. For more than a century, writers and philosophers have discussed a related concept—a “Law of Attraction.” There is no single definition for the Law of Attraction, and opinions vary as to its precise meaning or applicability. Nevertheless, the basic notion is that one's steady beliefs, thoughts, or earnest focus can affect one's well-being. For example, in 1909, author William Walker Atkinson explained that the Law of Attraction is not merely steadily wishing a person may “get there” or otherwise improve a situation, but also that the person “feels it and believes it, and thereby sets into operation the strongest forces known in the world of thought.” William Walker Atkinson, Thought Vibration or the Law of Attraction In The Thought World, Illinois: The New Thought Publishing Co., 1906, page 108.

More recently, authors Esther Hicks and Jerry Hicks further popularized the Law of Attraction in their book bearing the very name: The Law of Attraction. Esther Hicks and Jerry Hicks, The Law of Attraction, Hay House, 2007. One of the beliefs promoted is that by focusing one's thoughts for a period of time, for example: 68 seconds, the thoughts begin to take hold in the universe and to manifest themselves in a more physical sense. Rhonda Byrne advanced the popularity of the Law of Attraction in her book, and other related media, collectively termed The Secret®. Rhonda Byrne, The Secret, Simon & Schuster, 2007. The Secret® compiles a variety of oral traditions and literature found in religions and philosophies, including discussion and commentary pertaining to the Law of Attraction.

While meditating is a known art, which is a form of relaxation, focus, self-improvement, motivation, etc., there nevertheless remains a need for an improved timepiece apparatus and method for self improvement to allow a meditator to control the timing and duration of a meditative period.

### SUMMARY

An example embodiment of the present invention may include a timepiece apparatus comprising a housing, a surface coupled to the housing, a plurality of numerals on the surface, at least one actuator, and a rotatable arm structured to begin rotating from a starting position responsive to the actuator. The rotatable arm may sequentially traverse each of the plurality of numerals. Further, the rotatable arm may be structured to automatically stop rotating at the starting position.

Another example embodiment may include a method for counting time using a timepiece apparatus, the method comprising receiving a signal to begin rotating a rotatable arm of the timepiece, rotating the rotatable arm from a starting position responsive to the signal, and automatically stopping rotating the rotatable arm at the starting position. Rotating the rotatable arm may include sequentially traversing each of a plurality of numerals on a surface of the timepiece.

Yet another example embodiment may include a timepiece apparatus, comprising a housing, at least one actuator operatively coupled to the housing, and a display coupled to the housing and structured to show at least one numeral corresponding to seconds of time. The numerals may be incremented responsive to the actuator. The display may be structured to show the numerals incrementing from a predefined starting numeral to a predefined ending numeral. The predefined ending numeral may be greater than 60.

Some example embodiments may include a method for self improvement using a timepiece apparatus, comprising the timepiece apparatus beginning counting from a starting position responsive to a first input from a user, the timepiece apparatus notifying the user to start meditating using a first sensory effect, the timepiece apparatus traversing a plurality of seconds to an ending position more than 60 seconds from the starting position, the timepiece apparatus automatically stopping counting at the ending position, and the timepiece apparatus notifying the user to stop meditating using a second sensory effect.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 illustrates a perspective view of a timepiece apparatus according to a first embodiment.

FIG. 2 illustrates a plan view of the timepiece apparatus according to a second embodiment.

FIG. 3 illustrates a plan view of a digital timepiece apparatus according to a third embodiment.

FIG. 4 illustrates a plan view of the timepiece apparatus according to a fourth embodiment.

FIG. 5 illustrates a plan view of the digital timepiece apparatus according to a fifth embodiment.

FIG. 6 illustrates a plan view of the timepiece apparatus according to a sixth embodiment.

FIG. 7 illustrates a plan view of the timepiece apparatus according to a seventh embodiment.

FIG. 8 illustrates a plan view of the timepiece apparatus according to an eighth embodiment.

FIG. 9 illustrates a plan view of the timepiece apparatus according to a ninth embodiment.

FIG. 10 illustrates a flowchart of a procedure used to operate the timepiece apparatus.

FIG. 11 illustrates a flowchart of another procedure used to operate the timepiece apparatus.

FIG. 12 illustrates a flowchart of yet another procedure used to operate the timepiece apparatus.

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

### DETAILED DESCRIPTION OF THE EMBODIMENTS

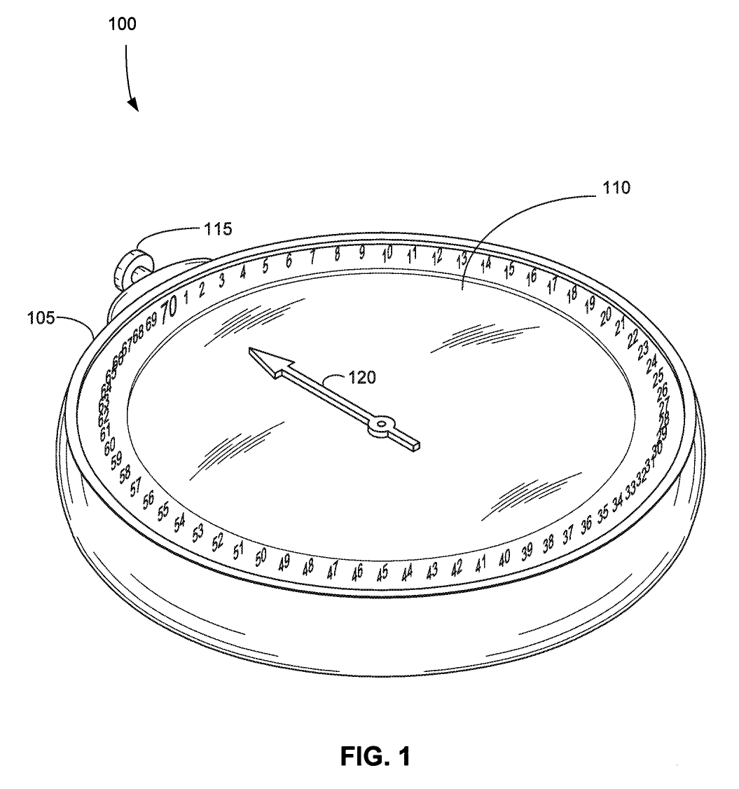

FIG. 1 illustrates an attractor timepiece apparatus 100 according to a first embodiment. While the timepiece apparatus 100 is sometimes referred to herein as an “attractor” timepiece apparatus, which refers to a timepiece suitable for aiding in the act of meditation, all of the embodiments are not limited thereto, but rather, some of the embodiments can take different forms and be applied for different purposes. The timepiece apparatus 100 may include a housing 105. A surface 110 may be coupled to the housing 105. An actuator 115 may also be coupled to the housing 105. A rotatable arm 120 may be structured to begin rotating from a starting position (e.g., 70) responsive to the actuator 115. The actuator 115 may comprise a button, a switch, or some other suitable sensor that is operatively associated with the timepiece apparatus 100. The timepiece apparatus 100 may be of such size so as to approximately fit snuggly or easily within a palm of an average sized hand, attached to a wrist, or hung about the neck. Alternatively, the timepiece apparatus 100 may be of such larger size so as to be placed upon a table, for example, or mounted on a wall, among other possibilities. In particular, the rotatable arm 120 may be structured to automatically stop rotating at the starting position (e.g., 70).

The timepiece apparatus 100 may comprise a plurality of numerals or other indicia. In the embodiment shown in FIG. 1, the timepiece apparatus 100 includes numerals 1 through 70 sequentially arranged towards a periphery of the surface 110 and disposed in a circular pattern. While FIG. 1 shows the numerals rising from a surface, this is an example configuration, and persons having skill in the art will recognize that the numerals may be oriented flat on the surface 110, or alternatively, oriented directly on a surface substantially perpendicular to surface 110 (not shown), among other possibilities. The numerals may be arranged in any pattern, and may range from 1 to X, where X is any numeral, but preferably greater than 60. For example, X can be 68 or 70, or thereabout. The rotatable arm 120 may sequentially traverse each of the numerals starting from 70 and may from there proceed to 1, 2, 3, . . . , 66, 67, 68, 69, and finally to 70, where the rotatable arm 120 may be structured to automatically stop at 70. The starting position of the rotatable arm 120 may be 70, which may initially correspond to 0 seconds of meditation. Then, as the meditation of a user ensues, the rotatable arm is structured to count from 0 seconds to 70 seconds. The ending position may therefore also correspond to 70. In other words, the starting position and the ending position, which are representative of the start of meditation and the end of meditation, may substantially be the same position.

In one example, the actuator 115 may be actuated by a user, which may cause the rotatable arm 120 to begin traversing the plurality of numerals. The movement of the rotatable arm 120 signals to the user that a meditative period of time is or should be ongoing. Once the rotatable arm 120 returns to the starting position (e.g., 70), then the rotatable arm 120 may automatically stop, signaling the user that the meditative period of time has or should be ended.

Alternatively, the actuator 115 may be actuated again by the user during the meditative period of time. If this occurs, then the rotatable arm 120 may substantially immediately move to the starting position (e.g., 70). In other words, if the actuator 115 is actuated while the rotatable arm 120 is traversing the plurality of numerals, the rotatable arm 120 may return to the starting position (e.g., 70), which essentially resets the timepiece apparatus 100 in preparation for a new meditative period. This feature allows the user to refocus any thoughts or meditative state after an unexpected interruption, and to begin the meditative period anew.

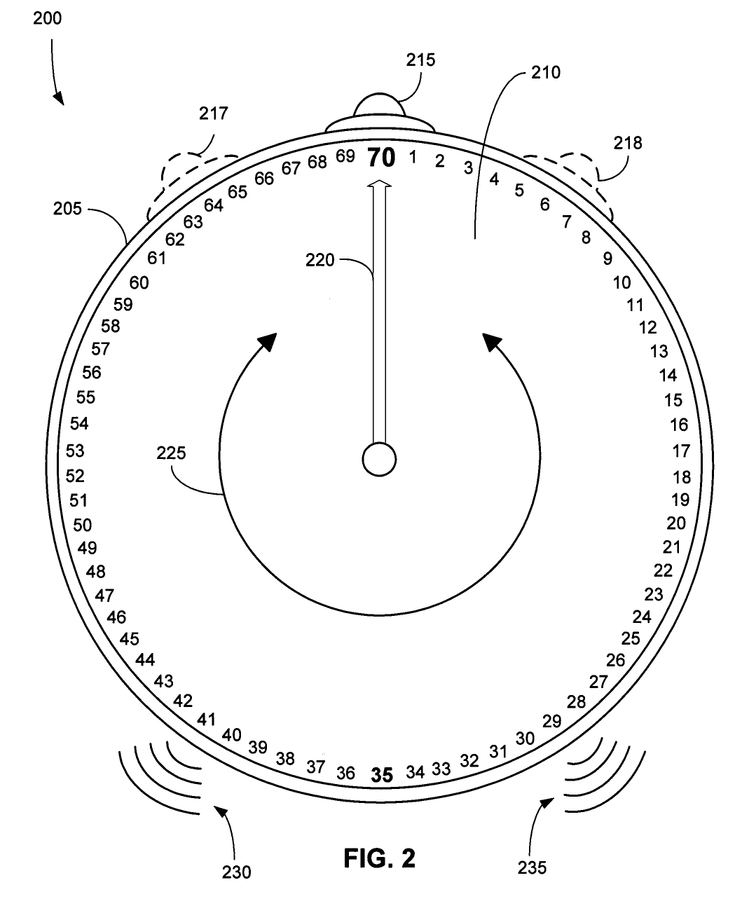

FIG. 2 illustrates the timepiece apparatus 200 according to a second embodiment. Similar to the timepiece apparatus 100 according to the first embodiment, the timepiece apparatus 200 may include a housing 205. A surface 210 may be coupled to the housing 205. In this embodiment, one or more actuators 215, 217, and 218 may be coupled to the housing 205. Each actuator may serve a different purpose, as will later be discussed. A rotatable arm 220 may be structured to begin rotating from a starting position (e.g., 70) responsive to one of the actuators 215, 217, or 218. Each of the actuators may comprise a button, a switch, or some other suitable sensor that is operatively associated with the timepiece apparatus 200. In particular, the rotatable arm 220 may be structured to automatically stop rotating at the starting position (e.g., 70).

The timepiece apparatus 200 may comprise a plurality of numerals or other indicia. In the embodiment shown in FIG. 2, the timepiece apparatus 200 includes numerals 1 through 70 sequentially arranged towards a periphery of the surface 210 and radially disposed in a circular pattern respective to the rotatable arm 220. The numerals, however, may be arranged in any pattern, and may range from 1 to X, where X is any numeral, but preferably greater than 60. For example, X may be 68 or 70, or thereabout. The rotatable arm 220 may sequentially traverse each of the numerals starting from 70 and may from there proceed to 1, 2, 3, . . . , 66, 67, 68, 69, and finally to 70, where the rotatable arm 220 may be structured to automatically stop at 70. The starting position of the rotatable arm 220 may be 70, which may initially correspond to 0 seconds of meditation. Then, as the meditation of a user ensues, the rotatable arm is structured to count from 0 seconds to 70 seconds. The ending position may therefore also correspond to 70. In other words, the starting position and the ending position, which are representative of the start of meditation and the end of meditation, may substantially be the same position.

The timepiece apparatus 200 of FIG. 2 may further comprise a first notification element 230 that is structured to notify a user of the timepiece, at about the time one of the actuators 215, 217, or 218 is actuated, that the rotatable arm 220 has started rotating. The timepiece apparatus 200 of FIG. 2 may also comprise a second notification element 235 that is structured to notify the user of the timepiece that the rotatable arm 220 has automatically stopped rotating, for example, when the rotatable arm 220 completes the traversal of the numerals or other indicia. Such second notification element 235 can bring the user from a meditative state to a more cognitive awareness that a sufficient meditative period has transpired and that the user can now stop meditating. Alternatively, the first notification element 230 may be structured to delay notifying the user by a predefined period of time, preferably about two seconds, after one of the actuators 215, 217, or 218 is actuated. In other words, the user of the timepiece apparatus 200 may be notified that the rotatable arm 220 has started rotating, after receiving the first notification element 230, after a predefined delay. This allows a two-second “warm-up” period for the user to begin focusing their thoughts prior to the actual meditative period, whereupon the meditative period would actually start when receiving the delayed notification.

Each of the first and second notification elements 230 and 235 may comprise a mechanism structured to generate a sensory effect. For example, the mechanism that is structured to generate the sensory effect may produce an audible signal including a beep, a buzz, a bell, a click, a tune, a chime, or a tone, among other possibilities. Moreover, the mechanism that is structured to generate the sensory effect may produce a vibration, a bump, or a shock, among other possibilities. The first and second sensory effects may be generated by the same mechanism and produce the same or different sensory effects, or may be generated by different mechanisms that each produce the same or different sensory effects.

Any of the actuators 215, 217, and 218 may be actuated by a user. For example, actuator 215 may be actuated by the user, which may cause the rotatable arm 220 to begin traversing the plurality of numerals. The movement of the rotatable arm 220 signals to the user that a meditative period of time is or should be ongoing. Once the rotatable arm 220 returns to the starting position (e.g., 70), then the rotatable arm 220 may automatically stop, signaling the user that the meditative period of time has or should be ended.

In addition, the actuator 217, for example, may be actuated by the user during the meditative period of time. If this occurs, then the rotatable arm 220 may substantially immediately move to the starting position (e.g., 70). In other words, if the actuator 217 is actuated while the rotatable arm 220 is traversing the plurality of numerals, the rotatable arm 220 may return to the starting position (e.g., 70), which essentially resets the timepiece apparatus 200 in preparation for a new meditative period. This feature allows the user to refocus any thoughts or meditative state after an unexpected interruption, and to begin the meditative period anew.

The actuator 218 may be used for additional control over the timepiece apparatus 200. For example, the actuator 218 may be used to pause the rotatable arm 220 partway through the meditative period to allow the user to attend to another matter, whereupon the actuator 218 may again be actuated to resume rotating the rotatable arm 220. The actuator 218 may also be an on/off switch or other timepiece control. The timepiece apparatus 200 may be battery operated or operated without batteries, such as through kinetic motion or manual winding. As shown in FIG. 2, by the curved double sided arrow 225, the rotatable arm 220 may rotate in either direction. While the timepiece apparatus 200 shows 70 as the starting and ending position, and 35 as the midpoint of the meditative period, such arrangement is for illustrative purposes, and other different arrangements of the numerals or other indicia may be used.

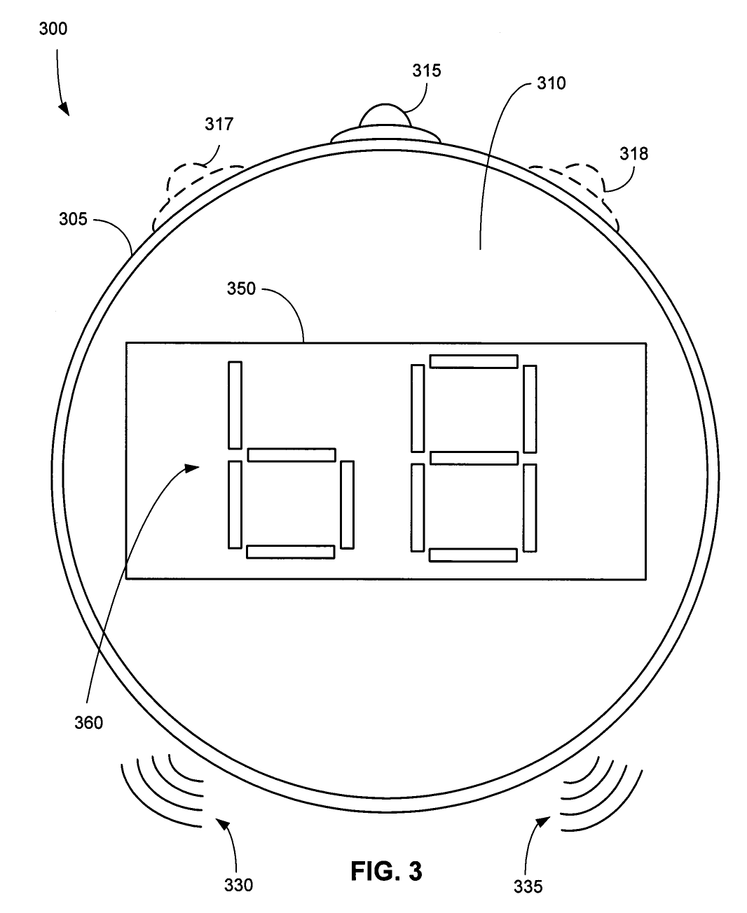

FIG. 3 illustrates a digital timepiece apparatus 300 according to a third embodiment. Similar to the timepiece apparatus 200 according to the second embodiment, the timepiece apparatus 300 may include a housing 305. A surface 310 may be coupled to the housing 305. In this embodiment, rather than numerals or other indicia being displayed in an analog fashion around the periphery of the surface, the numerals may be displayed using a digital display 350. In other words, the timepiece apparatus 300 may comprise a digital display 350 coupled to the housing 305 and structured to show at least one digital numeral 360 corresponding to seconds of time. The digital numeral 360 may be structured to increment responsive to one of the actuators 315, 317, or 318. The digital display 350 may show the digital numeral 360 incrementing from a predefined starting numeral (e.g., 0) to a predefined ending numeral (e.g., 68). Preferably, the predefined ending numeral is greater than 60. For example, the predefined ending numeral can be 68 or 70, or thereabout.

In this embodiment, the digital display 350 may sequentially increase each of the digital numerals 360 starting from 0 and may from there proceed to 1, 2, 3, . . . , 64, 65, 66, 67, and finally to 68, where the digital display 350 may automatically stop the digital numeral 360 at 68. In other words, the starting numeral may be 0, which may initially correspond to 0 seconds of meditation. Then, as the meditation of a user ensues, the digital display 350 is structured to count from 0 seconds to 68 seconds. The ending numeral may therefore be 68, which is different than the starting numeral of 0. As such, the starting and ending numerals, which are representative of the start of meditation and the end of meditation, need not correspond to the same numeral. Instead of timing the meditative period by starting from 0 seconds and incrementing to 68 seconds, the timepiece apparatus 300 may also time the meditative period by starting from 68 seconds and decrementing to 0 seconds. This can be accomplished using the digital display 350 in a similar fashion to that described above, except that the digital numerals 360 are decremented and automatically stopped at 0.

The timepiece apparatus 300 of FIG. 3 may further comprise a first notification element 330 that is structured to notify a user of the timepiece, at about the time one of the actuators 315, 317, or 318 is actuated, that the digital display 350 has started incrementing the digital numbers 360. The timepiece apparatus 300 of FIG. 3 may also comprise a second notification element 335 that is structured to notify the user of the timepiece that the digital display 350 has automatically stopped incrementing the digital number 360, for example, when the digital display 350 completes the traversal of the numerals or other indicia. Such second notification element 335 can bring the user from a meditative state to a more cognitive awareness that a sufficient meditative period has transpired and that the user can now stop meditating. Alternatively, the first notification element 330 may be structured to delay notifying the user by about two seconds after one of the actuators 315, 317, or 318 is actuated. This allows a two-second “warm-up” period for the user to begin focusing their thoughts prior to the actual meditative period, whereupon the meditative period would actually start when receiving the delayed notification.

Each of the first and second notification elements 330 and 335 may comprise a mechanism structured to generate a sensory effect. For example, the mechanism that is structured to generate the sensory effect may produce an audible signal including a beep, a buzz, a bell, a click, a tune, a chime, or a tone, among other possibilities. Moreover, the mechanism that is structured to generate the sensory effect may produce a vibration, a bump, or a shock, among other possibilities. The first and second sensory effects may be generated by the same mechanism and produce the same or different sensory effects, or may be generated by different mechanisms that each produce the same or different sensory effects.

Pertaining to the actuators, the actuator 315 may be actuated by a user, which may cause the digital display 350 to begin traversing the plurality of digital numerals 360. The changing of the digital numerals 360 signals to the user that a meditative period of time is or should be ongoing. Once the digital numerals 360 reaches an ending numeral (e.g., 68), then the digital display 350 may automatically stop incrementing the digital numerals 360, signaling the user that the meditative period of time has or should be ended.

Alternatively, the actuator 315 may be actuated again by the user during the meditative period of time. If this occurs, then the digital display 350 may substantially immediately change the digital numeral 360 to the starting numeral (e.g., 0). In other words, if the actuator 315 is actuated while the digital display 350 is traversing the plurality of digital numerals 360, digital display 350 may return to the starting numeral (e.g., 0), which essentially resets the timepiece apparatus 300 in preparation for a new meditative period. This feature allows the user to refocus any thoughts or meditative state after an unexpected interruption, and to begin the meditative period anew.

Indeed, any of the actuators 315, 317, and 318 may be actuated by a user. For example, actuator 315 may be actuated by the user, which may cause the digital display 350 to begin traversing the plurality of numerals. The changing of the digital numerals 360 signals to the user that a meditative period of time is or should be ongoing. Once the digital display 350 reaches the ending digital numeral 360 (e.g., 68), then the digital display 350 may automatically stop incrementing the digital numerals 360, signaling the user that the meditative period of time has or should be ended.

In addition, the actuator 317, for example, may be actuated by the user during the meditative period of time. If this occurs, then the digital display 350 may substantially immediately change the digital numeral 360 to the starting numeral (e.g., 0). In other words, if the actuator 317 is actuated while the digital display 350 is traversing the plurality of numerals, the digital numeral 360 may return to the starting numeral (e.g., 0), which essentially resets the timepiece apparatus 300 in preparation for a new meditative period. As mentioned above, this feature allows the user to refocus any thoughts or meditative state after an unexpected interruption, and to begin the meditative period anew.

The actuator 318 may be used for additional control over the timepiece apparatus 300. For example, the actuator 318 may be used to pause the digital display 350 partway through the meditative period to allow the user to attend to another matter, whereupon the actuator 318 may again be actuated to resume incrementing the digital numerals 360 on the digital display 350. The actuator 318 may also be an on/off switch or other timepiece control. The timepiece apparatus 300 may be battery operated or operated without batteries, such as through kinetic motion or manual winding. The digital display 350 may increment or decrement the digital numerals 360. While the timepiece apparatus 300 shows 68 as the ending numeral, such arrangement is for illustrative purposes, and other different arrangements of the numerals or other indicia may be used.

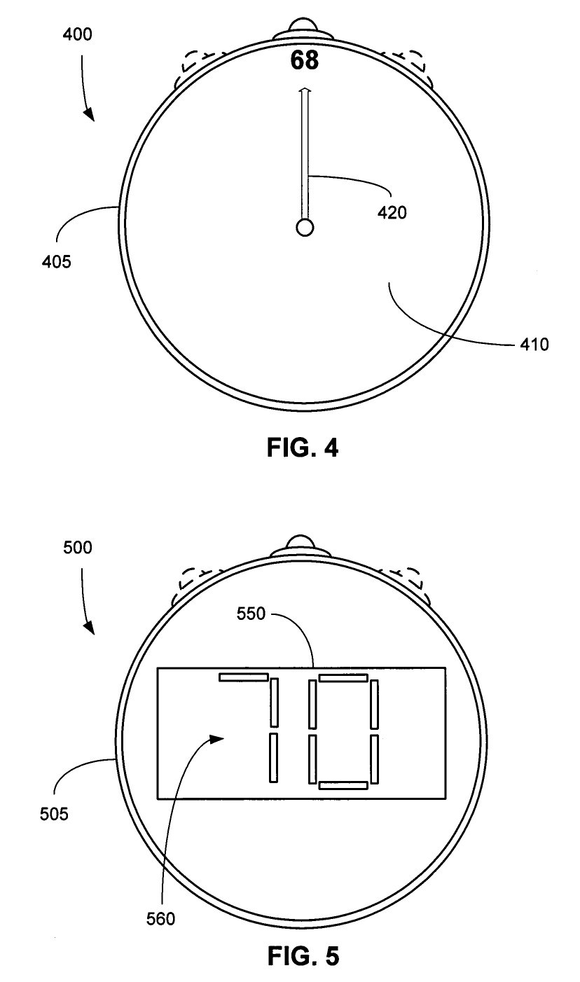

FIG. 4 illustrates the timepiece apparatus 400 according to a fourth embodiment. This embodiment is similar to the first and second embodiments of FIGS. 1 and 2 discussed above. The timepiece apparatus 400 comprises a housing 405, a surface 410, and a rotatable arm 420, among other elements previously discussed. However, the timepiece apparatus 400 need not include numerals or indicia along the periphery of the entire surface 410. For example, the timepiece apparatus 400 may only include the numeral (e.g., 68) corresponding to the starting and ending positions. Otherwise, the timepiece apparatus 400 may be constructed or operated in a similar fashion to the timepieces with reference to the first and second embodiments of FIGS. 1 and 2; therefore, for the sake of brevity, a detailed description of such will be omitted.

FIG. 5 illustrates the digital timepiece apparatus 500 according to a fifth embodiment. This embodiment is similar to the third embodiment of FIG. 3 discussed above. The timepiece apparatus 500 comprises a housing 505, a digital display 550, and digital numerals 560, among other elements previously discussed. However, the timepiece apparatus 500 can have an ending numeral other than 68. For example, the ending numeral can be 70, as shown in FIG. 5. As previously mentioned, the starting numeral can be 70, for example, and the digital display 350 may decrement the digital numerals 560 during the meditative period until reaching 0. The timepiece apparatus 500 may be constructed or operated in a similar fashion to the timepieces with reference to the third embodiment of FIG. 3; therefore, for the sake of brevity, a detailed description of such will be omitted.

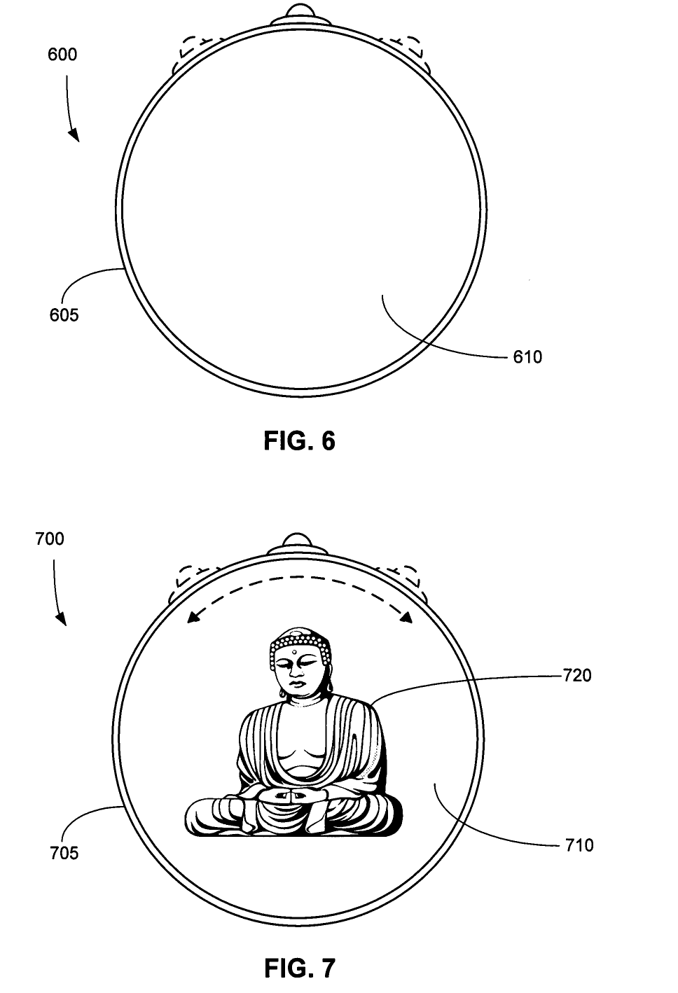

FIG. 6 illustrates the attractor timepiece apparatus 600 according to a sixth embodiment. This embodiment is similar to the previously discussed embodiments. The timepiece apparatus 600 comprises a housing 605 and a surface 610, among other elements previously discussed. However, the timepiece apparatus 600 need not include any numerals or indicia along the periphery of the surface 610, need not include a rotatable arm, and need not include a digital display. Nevertheless, the timepiece apparatus 600 may include one or more actuators and notification elements (not shown), and may be operated in a similar fashion to the embodiments described above. For example, upon actuating an actuator, the timepiece apparatus 600 may activate a first notification element signaling the user to begin a meditative period, and may then automatically activate a second notification element signaling the user to end the meditative period. Any of the functionality or operability discussed above may be applicable to the embodiment shown in FIG. 6, but without the physical elements of the display of the numerals, the rotating arm, and the like.

FIG. 7 illustrates the timepiece apparatus 700 according to a seventh embodiment. This embodiment is similar to the previously discussed embodiments. The timepiece apparatus 700 comprises a housing 705 and a surface 710, among other elements previously discussed. However, the timepiece apparatus 700 need not include any numerals or indicia along the periphery of the surface 710. Instead of a rotatable arm, the timepiece apparatus 700 may include an icon 720, either rotatable or fixed. The icon 720 may rotate in a similar fashion to the rotatable arm discussed with reference to previous embodiments. Alternatively, the icon 720 may be included merely to persuade the user to enter a meditative state, for example, by displaying an icon of a Buddha. In any case, the timepiece apparatus 700 may include one or more actuators and notification elements (not shown), and may be operated in a similar fashion to the embodiments described above. For example, upon actuating an actuator, the timepiece apparatus 700 may activate a first notification element signaling the user to begin a meditative period, upon which the icon 720 rotates from a starting position to an ending position, and may then automatically activate a second notification element signaling the user to end the meditative period. The starting position and the ending position of the icon 720 may be substantially the same position. Any of the functionality or operability discussed above may be applicable to the embodiment shown in FIG. 7, the detailed description of which will be omitted here for the sake of brevity.

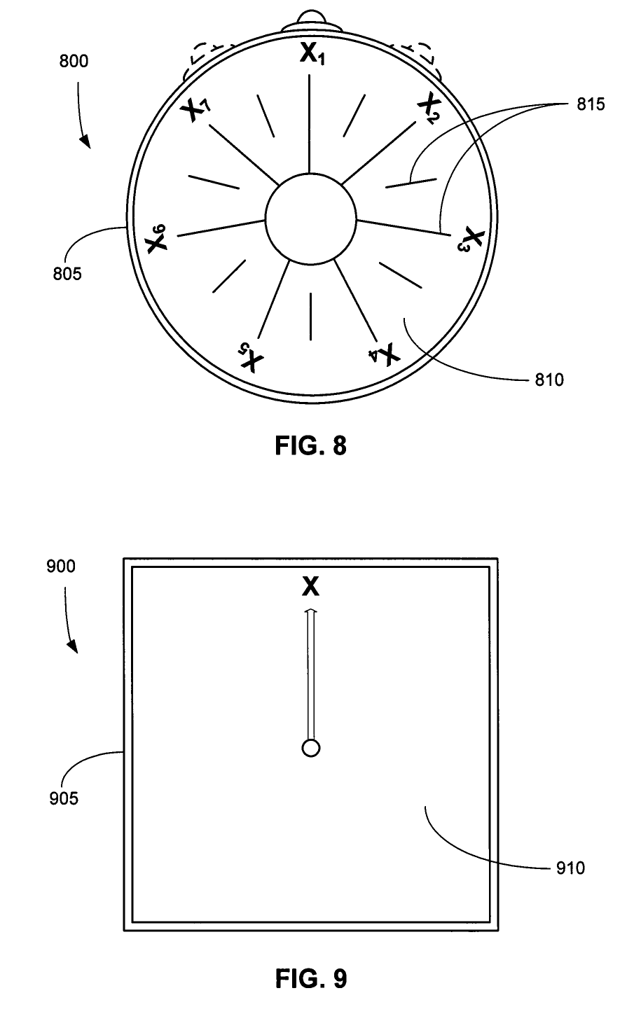

FIG. 8 illustrates the timepiece apparatus 800 according to an eighth embodiment. This embodiment is similar to the previously discussed embodiments. The timepiece apparatus 800 comprises a housing 805 and a surface 810, among other elements previously discussed. However, the timepiece apparatus 800 may include indicia X₁, X₂, . . . , X₆, and X₇, other than numerals, along the periphery of the surface 810. The surface 810 may also include lines 815 to help delineate the meditative period into yet finer periods of time. These may aid the user in knowing how far along the meditative period has advanced, and for how much longer the user's thoughts should remain focused. Any of the functionality or operability discussed above may be applicable to the embodiment shown in FIG. 8, the detailed description of which will be omitted here for the sake of brevity.

FIG. 9 illustrates the timepiece apparatus 900 according to a ninth embodiment. This embodiment is similar to the previously discussed embodiments. The timepiece apparatus 900 comprises a housing 905 and a surface 910, among other elements previously discussed. However, the timepiece apparatus 900 comprises a housing 905 that is in the shape of a square. This embodiment if for illustrative purposes and the housing 905 may be formed in any shape. Any of the functionality or operability discussed above may be applicable to the embodiment shown in FIG. 9, the detailed description of which will be omitted here for the sake of brevity.

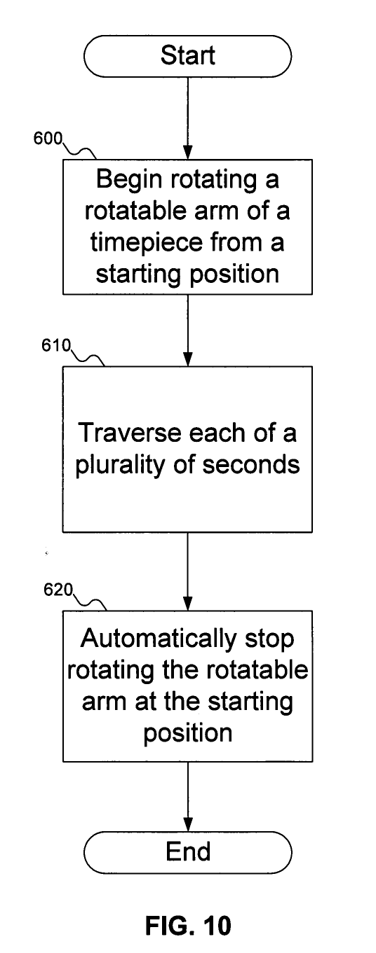

FIG. 10 illustrates a flowchart of a procedure used to operate the timepiece apparatus. This process may begin at 600 by rotating a rotatable arm of a timepiece apparatus from a starting position. As previously mentioned, the starting position may correspond to 68, 70, or 0, among other possibilities. Thereafter, a plurality of seconds may be traversed at 610, whereupon the rotatable arm is automatically stopped at the starting position as shown at 620.

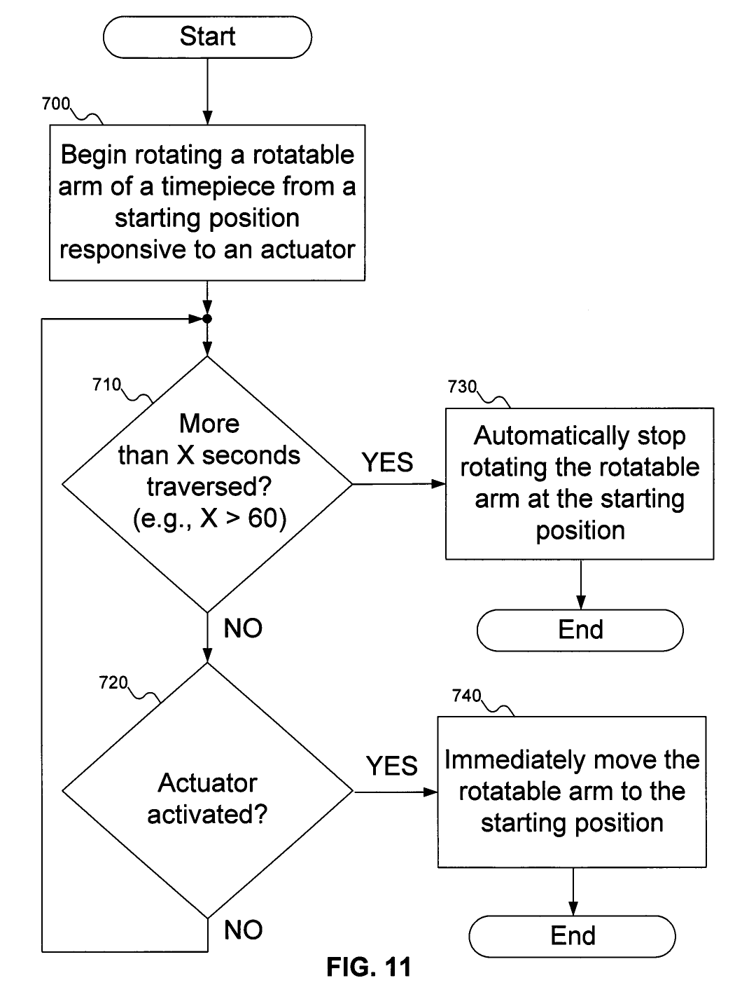

FIG. 11 illustrates a flowchart of another procedure used to operate the timepiece apparatus. Here, the process may begin at 700 by receiving a signal to begin rotating a rotatable arm of the timepiece from a starting position. The signal may be received responsive to an actuator, for example. A plurality of numerals on a surface of the timepiece may be traversed. For example, more than 60 seconds indicated by numerals on the surface of the timepiece may be traversed. The rotatable arm may be rotated from a starting position responsive to the signal. At 710, a determination can be made whether more than 60 seconds have been traversed. If so, the process can proceed to 730, and the rotatable arm may be automatically stopped at the starting position. Otherwise, the process can proceed to 720, whereupon a determination can be made whether the actuator has been activated while rotating the arm or otherwise traversing the numerals. If so, the process can proceed to 740 whereupon the rotatable arm is substantially immediately moved to the starting position. If not, the process can return to 710. The signal mentioned herein can be generated by actuating an actuator coupled to the timepiece, pushing a button, activating a switch, or activating a sensor, among other possibilities.

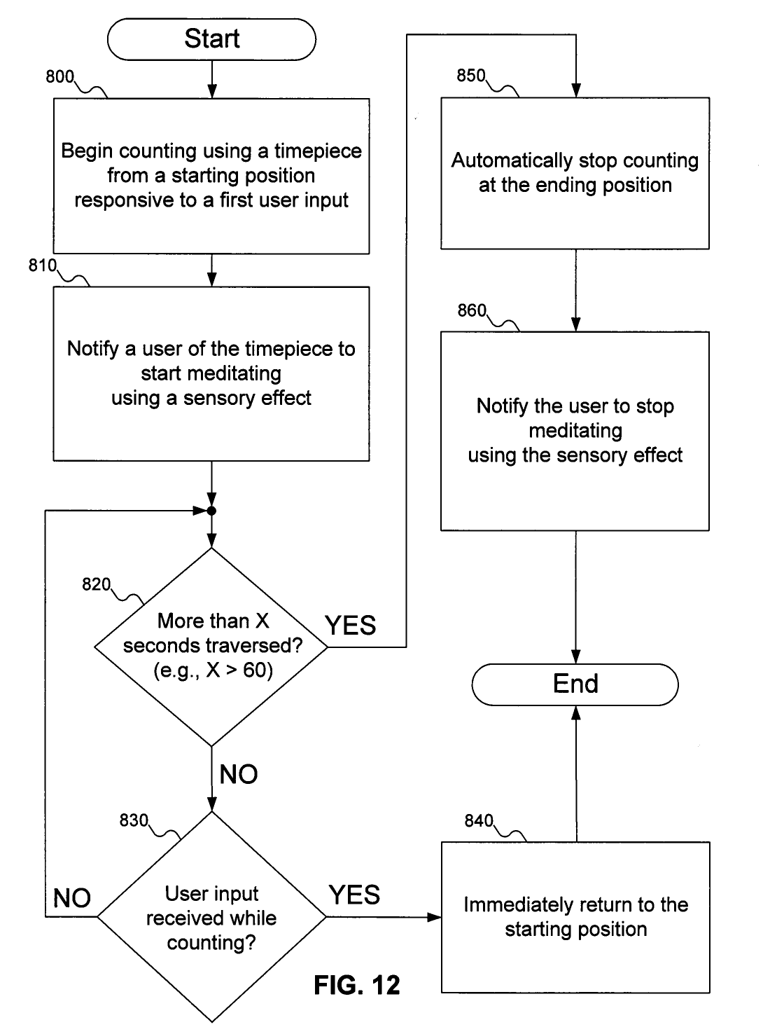

FIG. 12 illustrates a flowchart of yet another procedure used to operate the timepiece apparatus. The process may begin at 800 when the timepiece apparatus begins counting from a starting position responsive to a first user input. At 810, the user of the timepiece apparatus may be notified or otherwise signaled to start meditating. This can be accomplished through the use of a first sensory effect, which was previously described in detail above. The timepiece apparatus may proceed to traverse a plurality of seconds to an ending position more than 60 seconds from the starting position. In this example embodiment, either analog or digital versions of the timepiece apparatus may be used.

At 820, a determination can be made whether a plurality of seconds have been traversed to an ending position more than 60 seconds from the starting position. If so, the process can proceed to 850, whereupon the timepiece apparatus may automatically stop counting at the ending position. The ending position may or may not correspond to the starting position. At 860, the timepiece apparatus may notify the user to stop meditating using a second sensory effect. In other words, the second sensory effect may bring the user from a meditative state to a more cognitive awareness that a sufficient meditative period has transpired and that the user can now stop meditating. The first and second sensory effects may be of substantially the same kind, or alternatively, the first sensory effect can be of a first kind, and the second sensory effect can be of a second kind. In any case, the first and second sensory effects are detectable by the user of the timepiece apparatus.

If the decision at 820 results in a determination that the plurality of seconds have not been traversed to the ending position more than 60 seconds from the starting position, then the process can proceed to 830, whereupon a determination can be made whether a second user input was received while counting or otherwise traversing the plurality of seconds. If it is determined that the second user input was received, the timepiece apparatus may substantially immediately return to the starting position at 840.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A timepiece, comprising:
a housing;
a surface coupled to the housing;
a plurality of numerals on the surface;
at least one actuator; and
a rotatable arm structured to begin rotating from a starting position responsive to the at least one actuator, wherein:
the rotatable arm is structured to sequentially traverse each of the plurality of numerals, and
the rotatable arm is structured to automatically stop rotating at the starting position.

2. The timepiece of claim 1, wherein the plurality of numerals comprise positive integers from 1 to X, wherein X is greater than 60.

3. The timepiece of claim 2, wherein the starting position corresponds to X.

4. The timepiece of claim 3, wherein X is 70.

5. The timepiece of claim 4, wherein:
the starting position corresponds to 0 seconds,
the rotatable arm is structured to count from 0 seconds to 70 seconds,
an ending position corresponds to 70 seconds, and
the starting position and the ending position are substantially the same position.

6. The timepiece of claim 1, further comprising a first notification element structured to notify a user of the timepiece, at about the time the at least one actuator is actuated, that the rotatable arm has started rotating.

7. The timepiece of claim 6, further comprising a second notification element structured to notify the user of the timepiece that the rotatable arm has automatically stopped rotating.

8. The timepiece of claim 7, wherein each of the first and second notification elements comprises a mechanism structured to generate a sensory effect.

9. The timepiece of claim 8, wherein the mechanism that is structured to generate the sensory effect produces an audible signal including at least one of a beep, a buzz, a bell, a click, a tune, a chime, and a tone.

10. The timepiece of claim 8, wherein the mechanism that is structured to generate the sensory effect produces at least one of a vibration, a bump, and a shock.

11. The timepiece of claim 1, wherein:
the at least one actuator comprises at least one of a button, a switch, and a sensor,
the surface comprises a substantially circular shape, and
the plurality of numerals are radially disposed on the surface respective to the rotatable arm.

12. The timepiece of claim 1, wherein the rotatable arm is structured to substantially immediately move to the starting position when the at least one actuator is actuated while traversing the plurality of numerals.

13. A method for counting time using a timepiece, the method comprising:
receiving a signal to begin rotating a rotatable arm of the timepiece;
rotating the rotatable arm from a starting position responsive to the signal, wherein rotating includes sequentially traversing each of a plurality of numerals on a surface of the timepiece; and
automatically stopping rotating the rotatable arm at the starting position.

14. The method of claim 13, wherein the plurality of numerals comprise positive integers from 1 to X, wherein X is greater than 60.

15. The method of claim 14, wherein the starting position corresponds to X.

16. The method of claim 15, wherein X is 70.

17. The method of claim 16, wherein:
the starting position corresponds to 0 seconds,
an ending position corresponds to 70 seconds,
rotating further includes rotating the rotatable arm from the starting position corresponding to 0 seconds to the ending position corresponding to 70 seconds and sequentially traversing each of the plurality of numerals on the surface of the timepiece, and
the starting position and the ending position are substantially the same position.

18. The method of claim 17, wherein the signal comprises a first signal, and wherein the method further comprises:
after automatically stopping rotating the rotatable arm at the ending position, receiving a second signal to begin rotating the rotatable arm of the timepiece;
rotating the rotatable arm from the starting position responsive to the second signal, wherein rotating includes sequentially traversing each of the plurality of numerals on the surface of the timepiece; and
automatically stopping rotating the rotatable arm at the ending position.

19. The method of claim 13, further comprising notifying a user of the timepiece, at about the time of receiving the signal, that the rotatable arm has started rotating.

20. The method of claim 19, further comprising notifying the user of the timepiece at about the time of stopping rotating the rotatable arm.

21. The method of claim 20, wherein notifying the user includes generating a sensory effect.

22. The method of claim 21, wherein generating the sensory effect includes producing an audible signal that includes at least one of a beep, a buzz, a bell, a click, and a tune.

23. The method of claim 21, wherein generating the sensory effect includes producing at least one of a vibration, a bump, and a shock.

24. The method of claim 13, further comprising generating the signal by performing at least one of (a) actuating an actuator coupled to the timepiece, (b) pushing a button, (c) activating a switch, and (d) activating a sensor.

25. The method of claim 13, wherein the signal comprises a first signal, the method further comprising substantially immediately moving the rotatable arm to the starting position responsive to receiving a second signal while traversing the plurality of numerals.

26. The method of claim 13, further comprising notifying a user of the timepiece, after receiving the signal and after a predefined delay, that the rotatable arm has started rotating.

27. The method of claim 26, wherein the predefined delay is about two seconds.

28. A timepiece apparatus, comprising:
a housing;
at least one actuator operatively coupled to the housing; and
a display coupled to the housing and structured to show at least one numeral corresponding to seconds of time, wherein:
the at least one numeral is structured to increment responsive to the at least one actuator, and
the display is structured to show the at least one numeral incrementing from a predefined starting numeral to a predefined ending numeral, wherein the predefined ending numeral is greater than 60.

29. The timepiece of claim 28, wherein the display comprises a digital display.

30. The timepiece of claim 28, wherein the display comprises an analog display.

31. The timepiece of claim 28, wherein the predefined ending numeral is 70.

32. The timepiece of claim 28, wherein the predefined ending numeral is 68.

33. A method for self improvement using an attractor timepiece apparatus, comprising:
the timepiece apparatus beginning counting from a starting position responsive to a first input from a user;
the timepiece apparatus notifying the user to start meditating using a first sensory effect;
the timepiece apparatus traversing a plurality of seconds to an ending position more than 60 seconds from the starting position;
the timepiece apparatus automatically stopping counting at the ending position; and
the timepiece apparatus notifying the user to stop meditating using a second sensory effect.

34. The method of claim 33, further comprising the timepiece apparatus immediately returning to the starting position responsive to a second input from the user if the second user input is received while traversing the plurality of seconds.

35. The method of claim 33, wherein the first sensory effect is substantially the same kind of sensory effect as the second sensory effect, and the first and second sensory effects are detectable by the user.

36. A method of operating a timepiece apparatus, comprising:
beginning rotating a rotatable arm of the timepiece apparatus from a starting position;
traversing each of a plurality of seconds; and
automatically stopping rotating the rotatable arm at the starting position.
